(19) United States
(12) Patent Application Publication
(10) Pub. No.: US 2025/0364867 A1
(43) Pub. Date: Nov. 27, 2025

(54) ELECTRIC MOTOR

(71) Applicant: TOYOTA BOSHOKU KABUSHIKI KAISHA, Aichi (JP)

(72) Inventor: Tadasuke HIGUCHI, Aichi-gun (JP)

(73) Assignee: TOYOTA BOSHOKU KABUSHIKI KAISHA, Aichi (JP)

(21) Appl. No.: 19/215,878

(22) Filed: May 22, 2025

(30) Foreign Application Priority Data
May 27, 2024 (JP) 2024-085416
Apr. 3, 2025 (JP) 2025-062013

(51) Int. Cl. H02K 7/06; H02K 1/278; H02K 7/116

(52) U.S. Cl. CPC H02K 7/063; H02K 1/278; H02K 7/116

(57) ABSTRACT

Provided is an electric motor having a stator in which stator coils are circumferentially arranged. A center of the circumference is defined as a first center, and a position shifted from the first center is defined as a second center. The electric motor comprises: a ring rotor that is arranged inside the stator and has an annular shape around the second center; an eccentric shaft that is supported to be rotatable about the first center and supports the ring rotor such that the ring rotor is rotatable about the second center; an output portion that outputs a rotation of the ring rotor; a detector that detects a position of the ring rotor or the eccentric shaft; and a controller that controls a timing for energizing each of the stator coils based on a detection signal from the detector.

### CROSS-REFERENCE TO RELATED APPLICATIONS

The present application claims the benefit of Japanese Patent Application No. 2024-085416 filed on May 27, 2024 with the Japan Patent Office, the entire disclosure of which is incorporated herein by reference.

### BACKGROUND

The present disclosure relates to an electric motor.

As described in Japanese Unexamined Patent Application Publication No. 2009-517105, many of electric motors supply rotational forces the respective driven members through decelerators.

### SUMMARY

Because of movable parts used in a decelerator, such as gears, noise and vibration easily occur in the decelerator. At present, measures taken to address this issue include strict control of dimensional accuracy and assembly accuracy of those movable parts and the use of sound insulating members. The present disclosure discloses an example of an electric motor configured to address this issue.

An electric motor having a stator in which stator coils are circumferentially arranged desirably has, for example, the following constituent features, provided that the circumferential center is a first center, and a position shifted from the first center is a second center.

The constituent features are as follows: a ring rotor that is arranged inside the stator and has an annular shape around the second center, the ring rotor including permanent magnets smaller in number than the stator coils, the permanent magnets being arranged such that N-poles and S-poles thereof are alternately disposed along an outer circumferential surface of the stator; an eccentric shaft that is supported to be rotatable about the first center and supports the ring rotor such that the ring rotor is rotatable about the second center; an output portion that outputs a rotation of the ring rotor about the second center; a detector that detects a position of the ring rotor or the eccentric shaft; and a controller that controls a timing for energizing each of the stator coils based on a detection signal from the detector.

This allows the output portion of the electric motor to rotate in a state where the rotation of the eccentric shaft is decelerated. Accordingly, it is possible to reduce noise and vibration as compared to a case where a decelerator comprising a plurality of gears is used.

The electric motor may have, for example, the following features. Specifically, the electric motor may comprise a second ring rotor. Provided that the ring rotor is a first ring rotor, that the output portion is a first output portion, and that a position shifted from the second center by 180 degrees relative to the first center is a third center, a second ring rotor is situated inside the stator in a state supported by the eccentric shaft to be rotatable about the third center and has an annular shape around the third center. The second ring rotor includes permanent magnets smaller in number than the stator coils, the permanent magnets being arranged such that north poles and south poles thereof are alternately disposed along the outer circumferential surface of the stator.

The electric motor may further have, for example, the following features. Specifically, the electric motor may comprise a second output portion that outputs a rotation of the second ring rotor about the third center.

In this configuration, the first ring rotor and the second ring rotor are disposed circumferentially 180 degrees apart from each other relative to the first center and rotate separately.

Thus, a decentering force generated in association with the rotation of the first ring rotor is canceled out by a decentering force generated in association with the second ring rotor. This makes it possible to reduce vibration occurred in the electric motor.

The electric motor may have the following configuration. Specifically, the first output portion may include a first rotation plate that is supported rotatably about the first center and a first turning plate that is integrated into the first ring rotor. One of the first rotation plate and the first turning plate may be provided with a first protrusion protruding toward another plate, and the other plate may be provided with a first hole that allows the first protrusion to fit therein.

The second output portion may include a second rotation plate that is supported rotatably about the first center and a second turning plate that is integrated into the second ring rotor. One of the second rotation plate and the second turning plate may be provided with a second protrusion protruding toward another plate, and the other plate may be provided with a second hole that allows the second protrusion to fit therein.

It is desirable that the electric motor further comprises a transmitter that transmits a rotation of the second rotation plate to the first rotation plate.

The first rotation plate and the second rotation plate each has a disc-like shape and includes, at an outer periphery thereof, a toothed portion of a gear. It is desirable that the transmitter includes a first gear portion that meshes with the toothed portion of the first rotation plate and a second gear portion that meshes with the toothed portion of the second rotation plate.

It is further desirable that the stator includes a core that is provided with a through hole through which the transmitter passes.

### BRIEF DESCRIPTION OF THE DRAWINGS

An example embodiment of the present disclosure will be described hereinafter with reference to the accompanying drawings, in which:

FIG. 1 is a diagram showing a structure of an electric motor in a first embodiment;

FIG. 2 is a cross-sectional diagram showing the structure of the electric motor in the first embodiment;

FIG. 3 is an exploded view showing the structure of the electric motor in the first embodiment;

FIG. 4 is a diagram showing the structure of the electric motor in the first embodiment;

FIG. 5 is a diagram showing a stator in the first embodiment;

FIG. 6 is a diagram showing an eccentric shaft and a ring rotor in the first embodiment;

FIG. 7 is a diagram showing an output portion in the first embodiment;

FIG. 8 is a chart showing energization timings of a controller in the first embodiment;

FIG. 9 is a diagram explaining operation of the electric motor in the first embodiment;

FIG. 10 is a diagram explaining operation of the electric motor in the first embodiment;

FIG. 11 is a diagram explaining operation of the electric motor in the first embodiment;

FIG. 12 is a diagram explaining operation of the electric motor in the first embodiment;

FIG. 13 is a diagram explaining operation of the electric motor in the first embodiment;

FIG. 14 is a diagram explaining operation of the electric motor in the first embodiment;

FIG. 15 is a diagram explaining operation of the electric motor in the first embodiment;

FIG. 16 is a diagram explaining operation of the electric motor in the first embodiment;

FIG. 17 is a diagram explaining operation of the electric motor in the first embodiment;

FIG. 18 is a diagram showing a structure of an electric motor in a second embodiment;

FIG. 19 is a cross-sectional diagram showing a structure of the electric motor in the second embodiment;

FIG. 20 is a diagram showing a positional relationship between a first ring rotor and a second ring rotor;

FIG. 21 is another diagram showing the positional relationship between the first ring rotor and the second ring rotor;

FIG. 22 is a diagram showing the structure of the electric motor in the second embodiment; and

FIG. 23 is a chart showing energization timings of a controller in the second embodiment.

### DETAILED DESCRIPTION OF EXEMPLARY EMBODIMENTS

“Embodiments” below describe examples of embodiments within the technical scope of the present disclosure. Matters specifying the invention that are recited in the appended claims are not limited to any specific configuration, structure, or the like that is shown in the embodiments described below.

The present embodiment is an example of an electric motor that supplies a drive force to a movable portion of a seat to be installed in a vehicle, such as an automobile (hereinafter referred to as a vehicle seat). Arrows indicating directions, hatched lines, and so on in the figures are shown so as to facilitate understanding of mutual relationships among the figures, shapes of members or portions, and so on.

At least a member or portion described with a reference numeral assigned thereto is at least one in number unless accompanied by a specifying term, such as “only one”. The electric motor of the present disclosure comprises at least elements including members and portions described with respective reference numerals assigned thereto, and structural portions shown in the drawings.

### First Embodiment

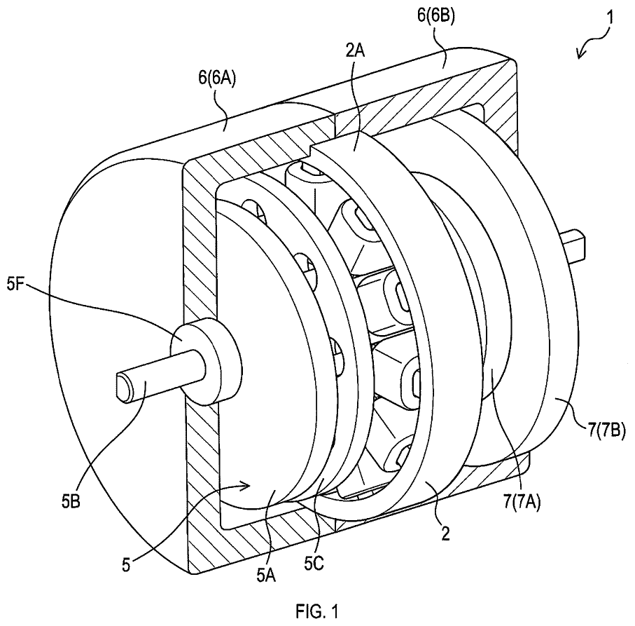

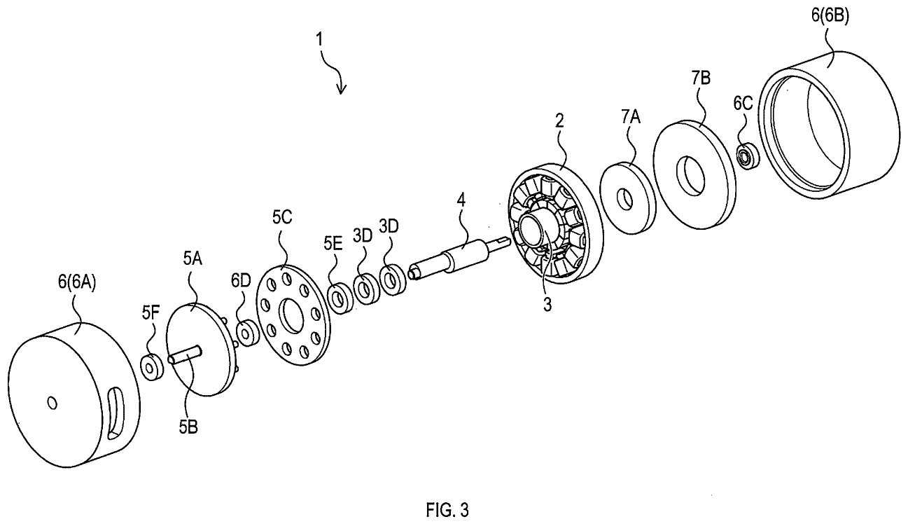

### <1. Configuration of Electric Motor (see FIGS. 1 to 6)>

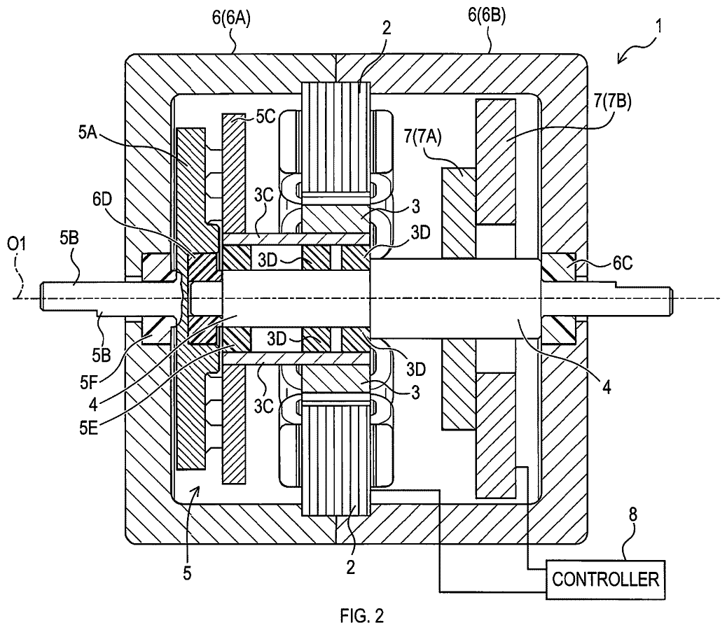

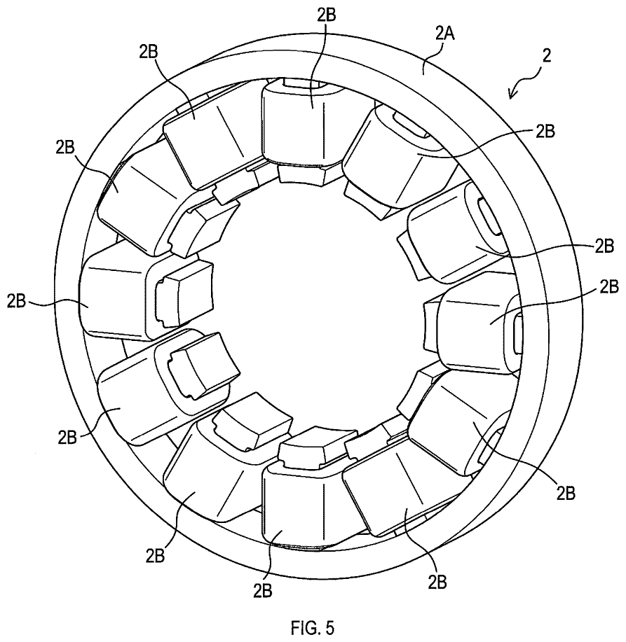

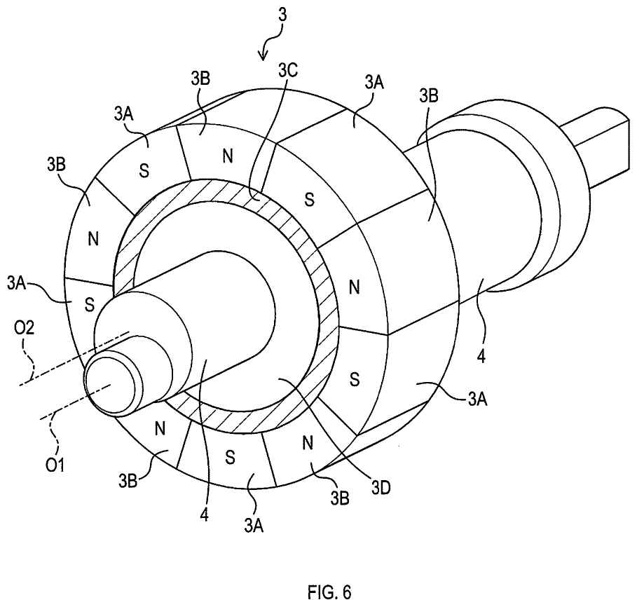

An electric motor 1 comprises: a stator 2 (see FIG. 5); a ring rotor 3 (see FIG. 6); an eccentric shaft 4 (see FIG. 6); an output portion 5 (see FIG. 2); a housing 6 (see FIGS. 1 to 3); a detector 7 (see FIG. 2); and a controller 8 (see FIG. 2).

### <Stator>

As shown in FIG. 5, the stator 2 includes an annular core (also referred to as a yoke) 2A and stator coils 2B. Each of the stator coils 2B is a winding that generates an electromagnetic force. The stator coils 2B are circumferentially disposed.

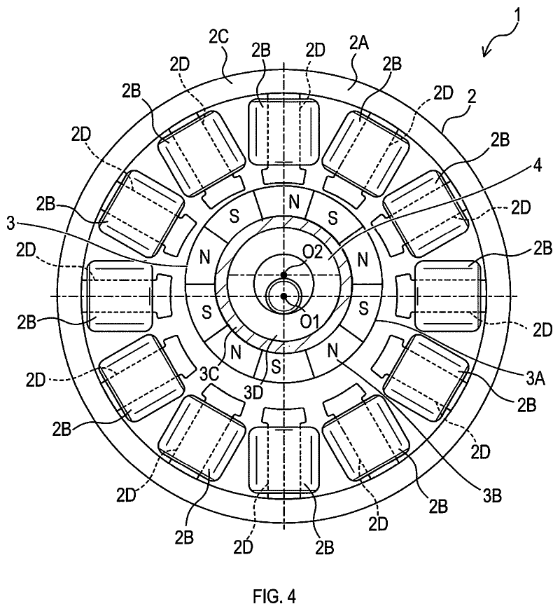

A core 2A forms a magnetic path for a magnetic flux induced by each of the stator coils 2B. As shown in FIG. 4, the core 2A includes an annular ring portion 2C and the same number of magnetic pole parts 2D as the stator coils 2B.

Each of the magnetic pole parts 2D protrudes toward a center of the ring portion 2C from an inner circumference of the ring portion 2C. The stator coils 2B are made of windings wound around the magnetic pole parts 2D. The ring portion 2C and each of the magnetic pole parts 2D are a single piece made up of a plurality of electrical steel sheets.

Each of the electrical steel sheets are stacked in a direction parallel to a rotational axis of the ring rotor 3 (see FIG. 2). Hereinafter, as shown in FIG. 4, the center of the ring portion 2C will be referred to as a first center O1, and a position shifted from the first center O1 will be referred to as a second center O2.

### <Ring Rotor>

As shown in FIG. 4, the ring rotor 3 is an annular member that is disposed inside the stator 2 and centered on the second center O2. As shown in FIG. 6, the ring rotor 3 includes permanent magnets 3A, 3B smaller in number than the magnetic pole parts 2D.

As the number of the permanent magnets 3A, 3B is smaller than the number of the magnetic pole parts 2D (the stator coils 2B), a central angle between centers of the permanent magnets 3A, 3B adjacent to one another is larger than a central angle between centers of the magnetic pole parts 2D (the stator coils 2B) adjacent to one another.

The central angle between the centers of the permanent magnets 3A, 3B means an angle formed by an imaginary line connecting the center of the permanent magnet 3A and the second center O2 and an imaginary line connecting the center of the permanent magnet 3B and the second center O2. The central angle between the centers of the magnetic pole parts 2D (the stator coils 2B) means an angle formed by an imaginary line connecting the center of a specific magnetic pole part 2D and the first center O1 and an imaginary line connecting the center of a magnetic pole part 2D adjacent to the specific magnetic pole part 2D and the first center O1.

In the present embodiment, the number of the magnetic pole parts 2D is twelve, and the number of the permanent magnets 3A, 3B is ten in total (the number of the permanent magnet 3A is five, and the number of the permanent magnet 3B is also five). Therefore, the central angle between the centers of the permanent magnets 3A, 3B is 36 degrees, and the central angle between the centers of the magnetic pole parts 2D is 30 degrees.

The permanent magnets 3A, 3B are arranged such that N-poles and S-poles thereof are alternately disposed circumferentially outwardly. Each of the permanent magnets 3A, 3B is attached to an outer circumferential surface of a cylindrical collar 3C. In other words, the collar 3C and the ring rotor 3 are integrated.

### <Eccentric Shaft>

As shown in FIG. 6, the eccentric shaft 4 supports the ring rotor 3 such that the ring rotor 3 is rotatable about the second center O2. Specifically, the collar 3C has a cylindrical shape having the second center O2 as a center axis. As shown in FIG. 2, a bearing 3D is provided to an inner circumference of the collar 3C.

Accordingly, the ring rotor 3 is rotatable with respect to the eccentric shaft 4 around the second center O2.

The eccentric shaft 4 is, as shown in FIG. 2, directly or indirectly supported by the housing 6. The eccentric shaft 4 is rotatable about the first center O1. One end of the eccentric shaft 4 in an axial direction is directly supported by the housing 6 via a bearing 6C.

Another end of the eccentric shaft 4 in the axial direction is indirectly supported by the housing 6 via a bearing 6D. Specifically, the bearing 6D is provided to a rotation plate 5A of the output portion 5. The rotation plate 5A is integrated with an output shaft 5B of the output portion 5, and the output shaft 5B is rotatably supported by the housing 6 via a bearing 5F.

### <Housing>

The housing 6 is a casing to house components such as the stator 2. The housing 6 includes a first housing 6A and a second housing 6B. The bearing 5F is provided to the first housing 6A. The bearing 6C is provided to the second housing 6B.

### <Output Portion>

The output portion 5 outputs the rotation of the ring rotor 3 about the second center O2. As shown in FIG. 2, the output portion 5 includes at least the rotation plate 5A, the output shaft 5B, and a turning plate 5C.

As described above, the rotation plate 5A and the output shaft 5B are integrated. The output shaft 5B is supported via the bearing 5F to be rotatable about the first center O1. Accordingly, the rotation plate 5A and the output shaft 5B are rotatable about the first center O1.

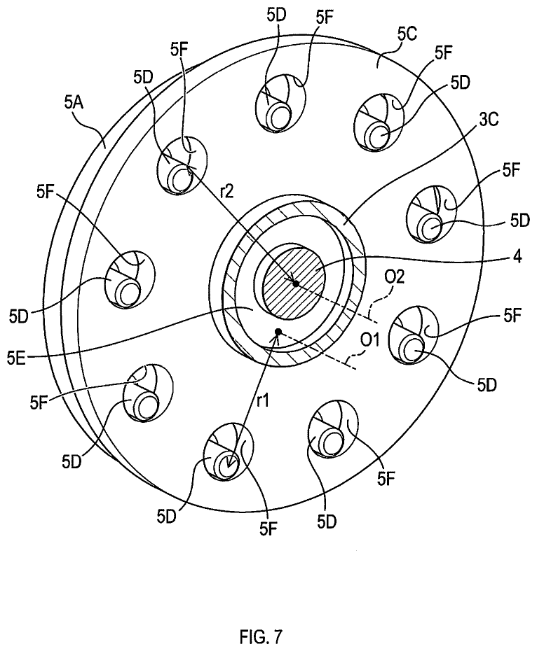

As shown in FIG. 7, the rotation plate 5A is a disc-like member including a plurality of columnar or cylindrical protrusions 5D circumferentially disposed about the first center O1. These protrusions 5D protrude toward the turning plate 5C.

As shown in FIG. 2, the turning plate 5C is integrated with the ring rotor 3 via the collar 3C. In other words, the turning plate 5C is supported on the eccentric shaft 4 via a bearing 5E. The turning plate 5C is rotatable about the second center O2.

As shown in FIG. 7, the turning plate 5C is provided with the same number of holes or recesses (in the present embodiment, through holes 5F) as the number of the protrusions 5D. These through holes 5F allow the protrusions 5D to fit therein and are circumferentially provided about the second center O2.

A distance r1 from a center of each of the protrusions 5D to the first center O1 is equal to a distance r2 from a center of each of the through holes 5F to the second center O2. Furthermore, a radius of each of the through holes 5F is equal to a distance between the first center O1 and the second center O2. An outer circumferential surface of each of the protrusions 5D is slidably contactable to an inner circumferential surface of a corresponding one of the through holes 5F.

### <Detector>

The detector 7 detects a position of the ring rotor 3 or the eccentric shaft 4. In the present embodiment, the detector 7 detects the position of the eccentric shaft 4. As shown in FIG. 2, the detector 7 includes a sensor magnetic plate 7A and a sensor board 7B that integrally rotate with the eccentric shaft 4.

The sensor magnetic plate 7A is provided with one or more magnetic substances, such as permanent magnets. The sensor board 7B includes a sensor, such as a hall IC, that detects a variation in a magnetic field. The sensor board 7B detects an angle of rotation of the eccentric shaft 4 based on the variation in the magnetic field in accordance with a rotation of the eccentric shaft 4.

### <Controller>

The controller 8 controls a timing for energizing each of the stator coils 2B based on a detection signal from the detector 7. Specifically, the controller 8 controls energization to either a single stator coil 2B or a set of the stator coils 2B.

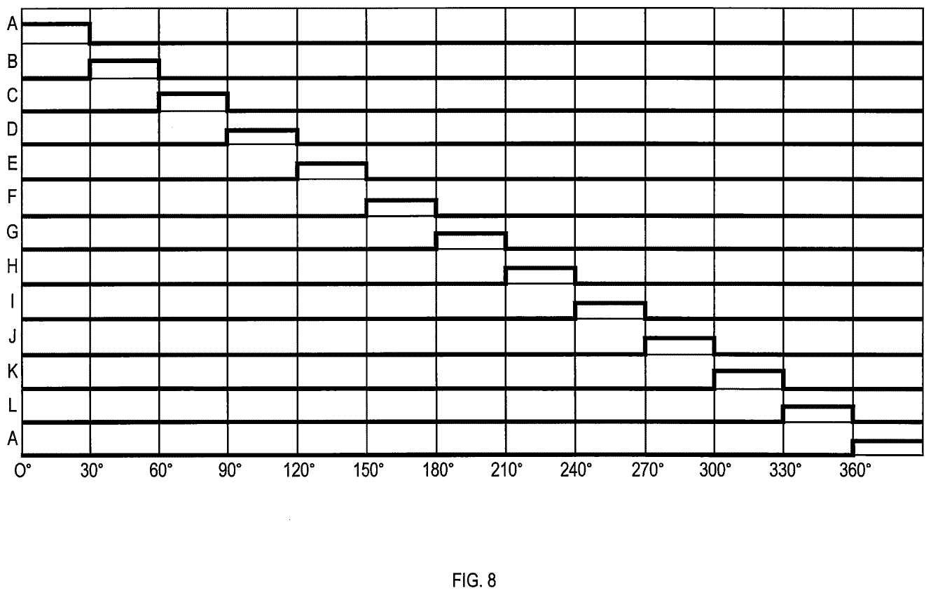

As shown in FIG. 8, the controller 8 energizes the stator coils 2B one by one along the ring portion 2C. In other words, an electromagnetic force rotating along the ring portion 2C is generated in the stator 2. Hereinafter, such a magnetic field will be also referred to as a rotating magnetic field.

### <2. Operation of Electric Motor>

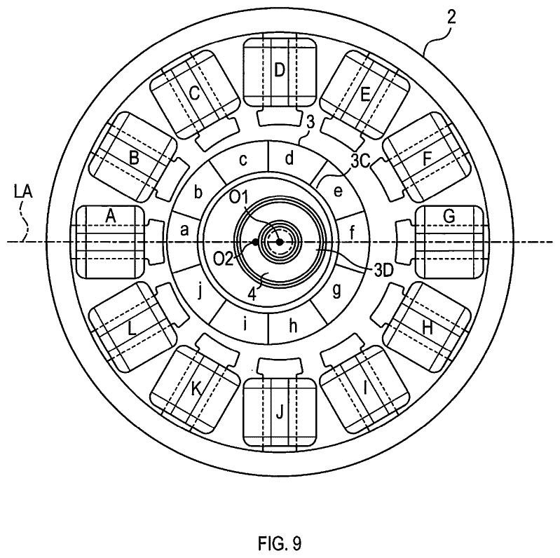

Hereinafter, as shown in FIG. 9, each of the stator coils 2B will be referred to as, a winding A, a winding B, . . . , and a winding L. Each of the permanent magnets 3A, 3B will be referred to as a magnet a, a magnet b, . . . , and a magnet j. The controller 8 energizes each of the stator coils 2B in the sequence: the winding A, the winding B, . . . , the winding L, the winding A, the winding B, . . . , the winding L, the winding A, the winding B, . . . (see FIG. 8).

Each of the stator coils 2B is configured such that the magnetic fields generated in the adjacent stator coils 2B have different polarities. Specifically, the magnetic pole generated upon energization to the winding A is distinct from the magnetic pole generated upon energization to the winding B.

Upon energization to the winding A, for example, the magnet proximal to the winding A is magnetically attracted to the winding A, causing the magnet a to move closer to the winding A, as shown in FIG. 9. Simultaneously, the ring rotor 3 and the eccentric shaft 4 rotate such that a center of the winding A (hereinafter, referred to as a winding center A), the second center O2, and the first center O1 lie on a straight line LA.

The ring rotor 3 is rotatable about the second center O2, and the eccentric shaft 4 is rotatable about the first center O1. While the winding A is energized, in a state where the winding center A, the second center O2, and the first center O1 lie on the straight line LA, the rotational force to cause the ring rotor 3 and the eccentric shaft 4 to rotate is zero.

Upon energization to any one of the windings A to L, the ring rotor 3 and the eccentric shaft 4 try to undergo rotational displacement until the winding center of the energized one of the stator coils 2B, the second center O2, and the first center O1 come to lie on the same straight line.

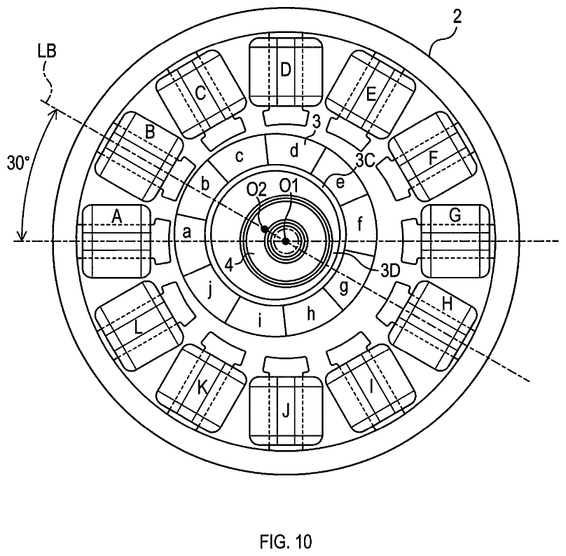

When the energized winding is changed from the winding A to the winding B, the ring rotor 3 and the eccentric shaft 4 rotate such that a winding center B, which is the center of the winding B, the second center O2, and the first center O1 lie on a straight line LB (see FIG. 10).

The eccentric shaft 4 rotates only by an angle formed by the straight line LA and the straight line LB (in the present embodiment, 30 degrees). Similarly, the second center O2 rotates about the first center O1 only by the aforementioned angle (30 degrees in the present embodiment).

The central angle between the centers of the permanent magnets 3A, 3B is greater than the central angle between the centers of the magnetic pole parts 2D. Accordingly, in order to cause the winding center, the second center O2, and the first center O1 to lie on the same straight line, the ring rotor 3 is required to rotate in a direction opposite to that of the eccentric shaft 4.

That is, a center of the magnet b is shifted from a center of the magnet a by 36 degrees with respect to the second center O2. Accordingly, in order to cause the winding center B, the second center O2, and the first center O1 to lie on the straight line LB, the ring rotor 3 is required to rotate only by 6 degrees about the second center O2 in a direction opposite to that of the eccentric shaft 4.

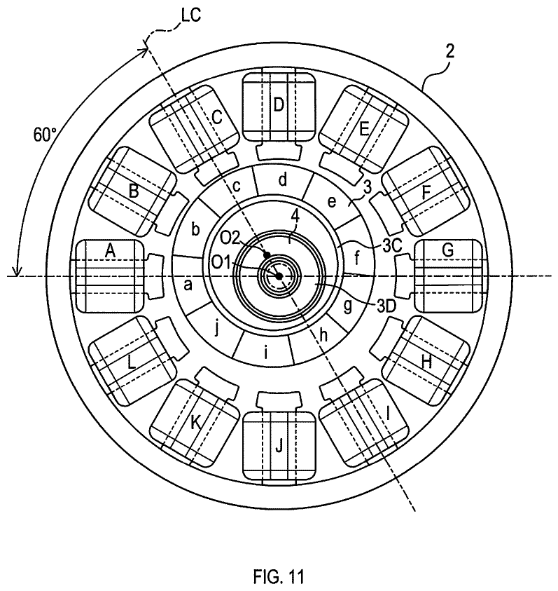

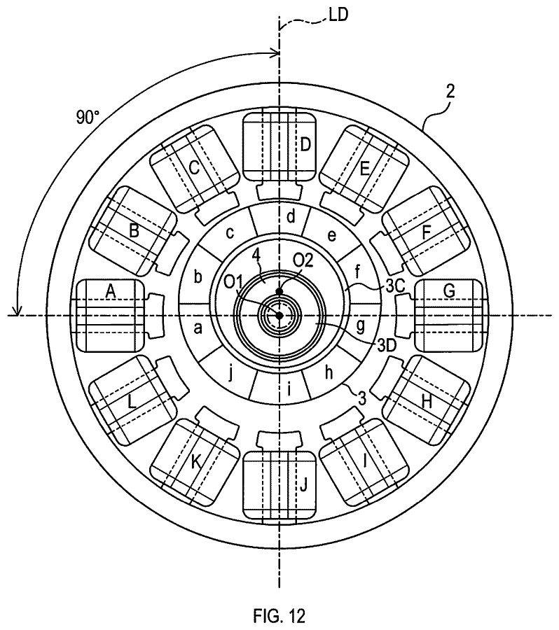

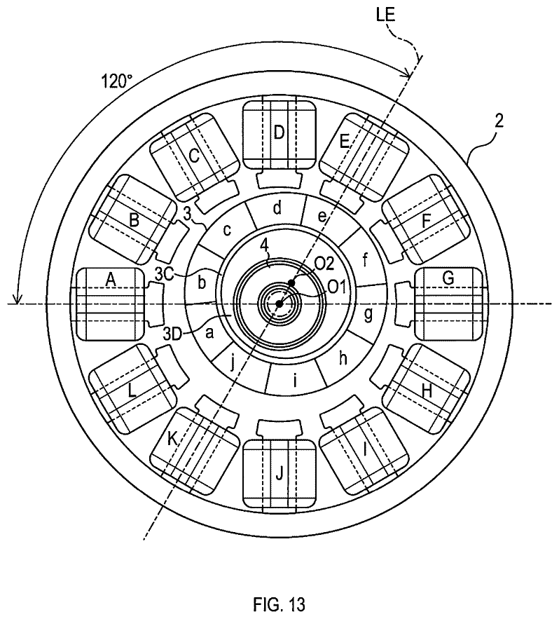

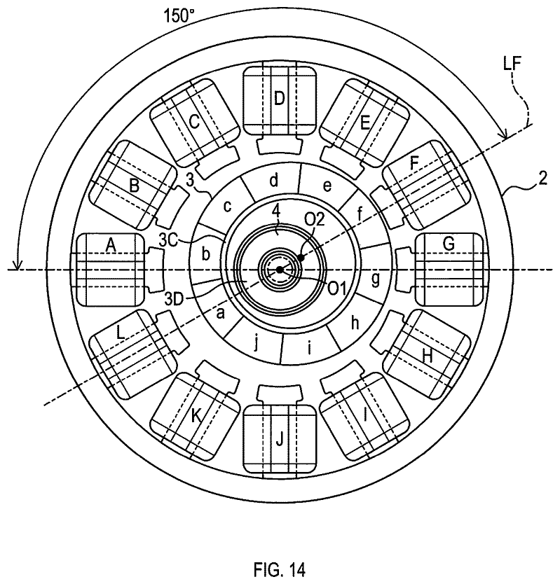

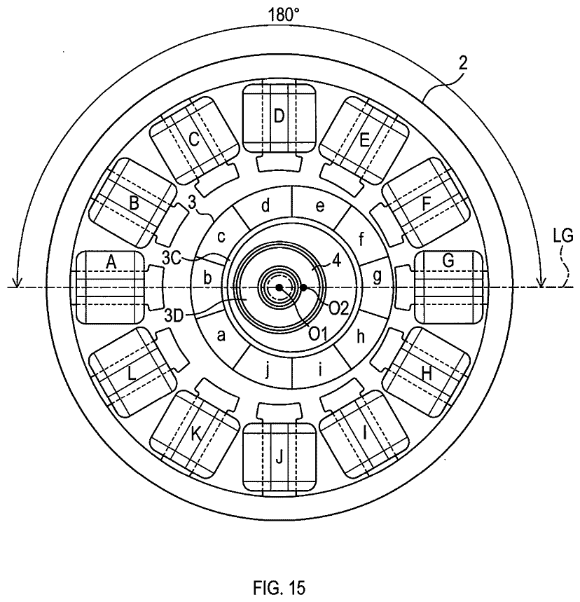

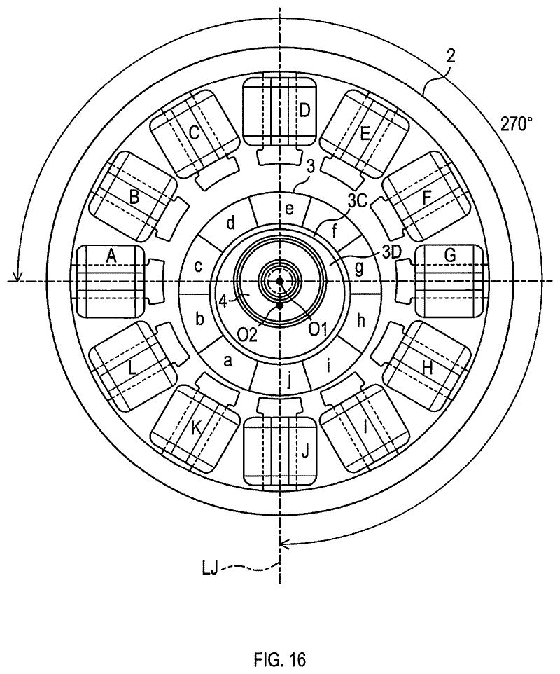

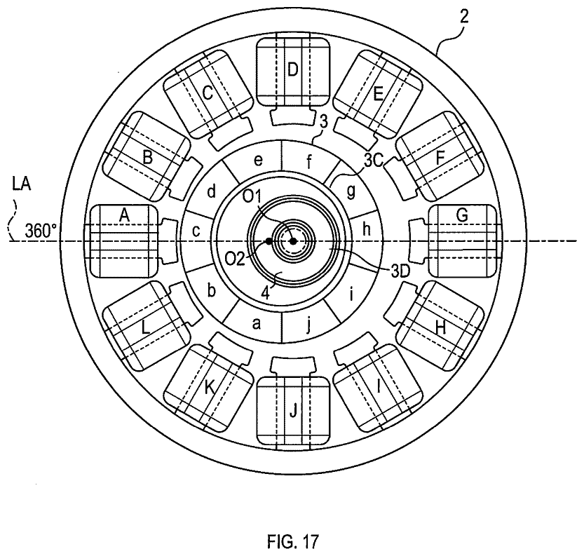

Thus, as electric currents are supplied to the respective stator coils 2B in the sequence: the winding A, the winding B, . . . , the winding L, the winding A, the eccentric shaft 4 makes a clockwise rotation of 30 degrees, every time the energized winding is changed from one to another, for example, as shown in FIG. 9, FIG. 10, FIG. 11, FIG. 12, FIG. 13, FIG. 14, FIG. 15, FIG. 16, and FIG. 17 in this order, thereby completing a rotation of 360 degrees.

Specifically, a straight line L through the winding center, the second center O2, and the first center O1 makes a clockwise rotation of 30 degrees about the first center O1 every time the energized winding is changed from one to another, as illustrated as LA, LB, LC, LD, . . . , LG, . . . , LK in this order, thereby completing a rotation of only 360 degrees.

At the same time, the ring rotor 3 makes a counterclockwise rotation of 6 degrees about the second center O2 every time the energized winding is changed from one to another, thereby completing a rotation of only 72 degrees. As the second center O2 rotates clockwise about the first center O1, the ring rotor 3 rotates clockwise about the first center O1 (this rotation will be referred to as a “turning” hereinafter).

While turning clockwise with respect to the housing 6, the ring rotor 3 rotates counterclockwise. Therefore, it is not possible to directly output the rotation of the ring rotor 3.

For this reason, in the present embodiment, the turning plate 5C is configured to integrally rotate and turn with the ring rotor 3, and the rotation of the ring rotor 3 is converted into the rotation about the first center O1 by the turning plate 5C and the rotation plate 5A.

In other words, in the present embodiment, the turning plate 5C and the rotation plate 5A together form a joint to absorb the shift between the output shaft 5B and the rotational axis of the ring rotor 3 and the turning of the ring rotor 3.

### <3. Features of Electric Motor>

As described above, the rotation of the ring rotor 3 converted into the rotation about the first center O1 is output externally via the output shaft 5B. In other words, with the use of the electric motor 1, it is possible to reduce noise and vibration as compared to a case where a decelerator comprising a plurality of gears is used.

### Second Embodiment

### <1. Configuration of Electric Motor in Second Embodiment>

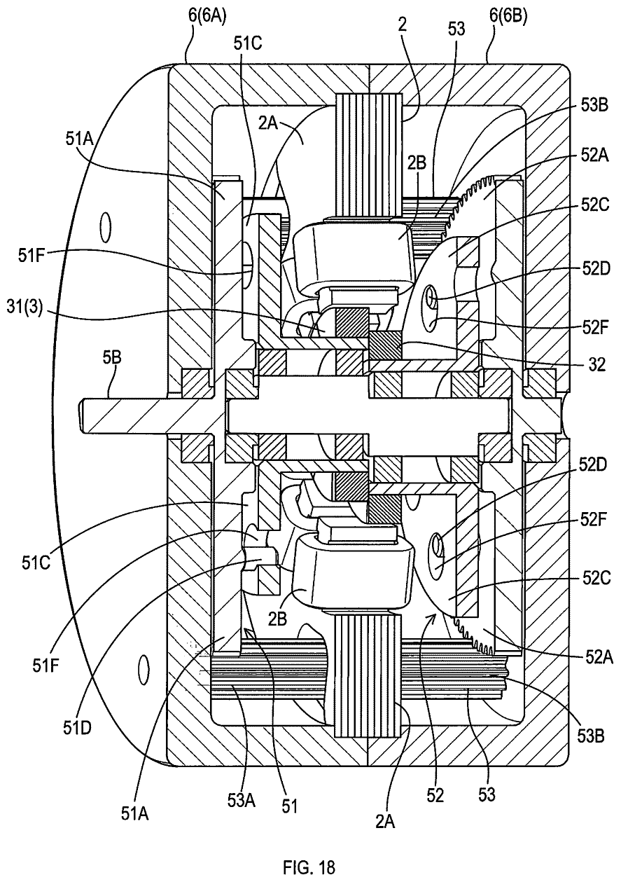

As shown in FIGS. 18 to 21, the electric motor 1 in the second embodiment comprises: a first ring rotor 31; a second ring rotor 32; and a transmitter 53. Each of the ring rotors 31, 32 is identical to the ring rotor 3 in the first embodiment.

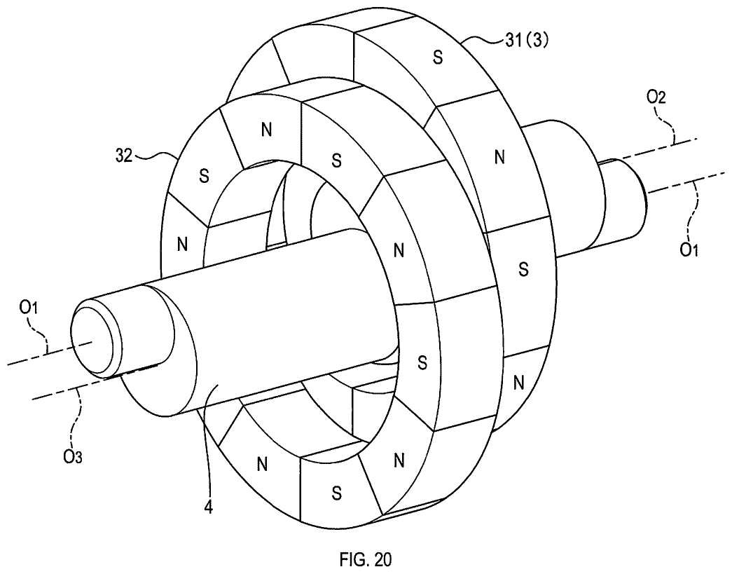

Similarly to the ring rotor 3 in the first embodiment, as shown in FIG. 20, the first ring rotor 31 is supported by the eccentric shaft 4 to be rotatable about the second center O2.

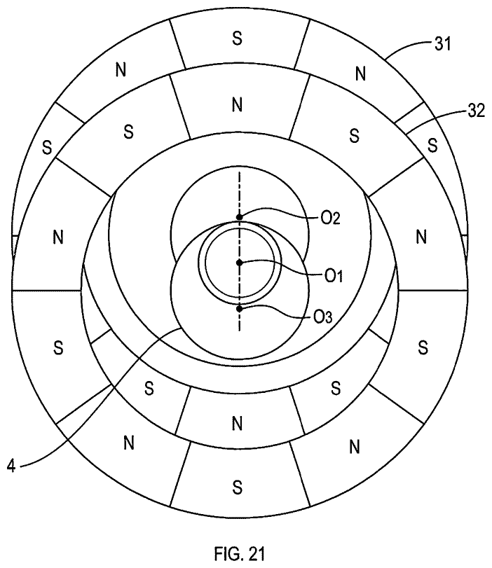

The second ring rotor 32 is supported by the eccentric shaft 4 to be rotatable about the third center O3. As shown in FIG. 21, the third center O3 is a position circumferentially shifted from the second center O2 by 180 degrees relative to the first center O1.

Thus, the third center O3 lies on an imaginary line drawn through the first center O1 and the second center O2 and is positioned opposite to the second center O2 across the first center O1. A distance between the first center O1 and the third center O3 is equal to that between the first center O1 and the second center O2.

As shown in FIG. 18, a first output portion 51 that transmits a rotation of the first ring rotor 31 to the output shaft 5B is identical to the output portion 5 in the first embodiment. Specifically, the first output portion 51 includes a first rotation plate 51A and a first turning plate 51C.

The first rotation plate 51A corresponds to the rotation plate 5A and is a disc-like member supported rotatably about the first center O1. The first turning plate 51C corresponds to the turning plate 5C and is a disc-like member integrated into the first ring rotor 31.

The first rotation plate 51A is provided with a first protrusion 51D protruding toward the first turning plate 51C. The first turning plate 51C is provided with a first hole 51F that allows the first protrusion 51D to fit therein.

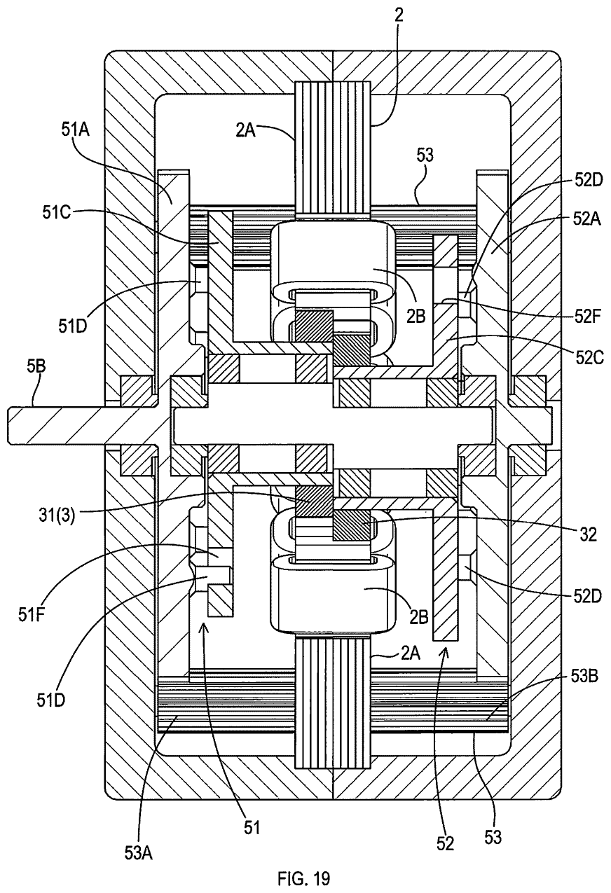

As shown in FIG. 19, a second output portion 52 that transmits a rotation of the second ring rotor 32 to the output shaft 5B is identical to the output portion 5 in the first embodiment. Specifically, the second output portion 52 includes a second rotation plate 52A and a second turning plate 52C.

The second rotation plate 52A corresponds to the rotation plate 5A and is a disc-like member supported rotatably about the first center O1. The second turning plate 52C corresponds to the turning plate 5C and is a disc-like member integrated into the second ring rotor 32.

The second rotation plate 52A is provided with a second protrusion 52D protruding toward the second turning plate 52C. The second turning plate 52C is provided with a second hole 52F that allows the second protrusion 52D to fit therein.

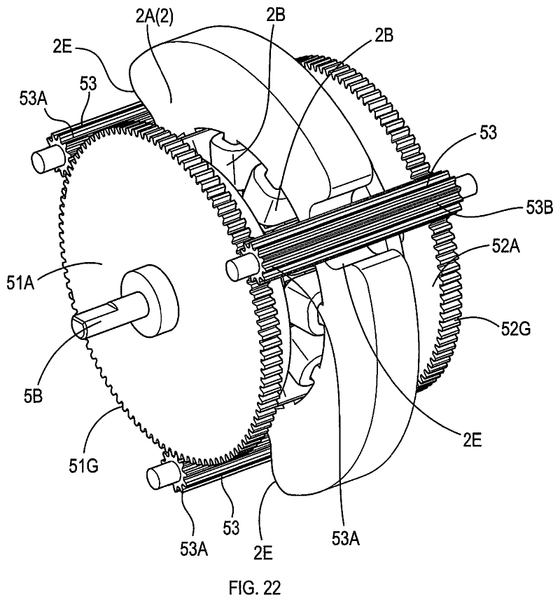

As shown in FIG. 22, the transmitter 53 extends in a direction parallel to the axial direction of the eccentric shaft 4 and transmits a rotation of the second rotation plate 52A to the first rotation plate 51A. In the second embodiment, a plurality of transmitters 53 are circumferentially disposed.

The first rotation plate 51A and the second rotation plate 52A respectively include, at outer peripheries thereof, a toothed portion 51G and a toothed portion 52G to constitute gears. The transmitters 53 each includes a first gear portion 53A and a second gear portion 53B.

The first gear portion 53A is configured to mesh with the toothed portion 51G of the first rotation plate 51A. The second gear portion 53B is configured to mesh with the toothed portion 52G of the second rotation plate 52A. There are through holes 2E provided in the core 2A of the stator 2 through which the transmitters 53 pass.

Each of the through holes 2E in the second embodiment is a concave void recessed from an outer periphery of the core 2A toward the eccentric shaft 4, penetrating through the core 2A in the direction parallel to the axial direction of the eccentric shaft 4.

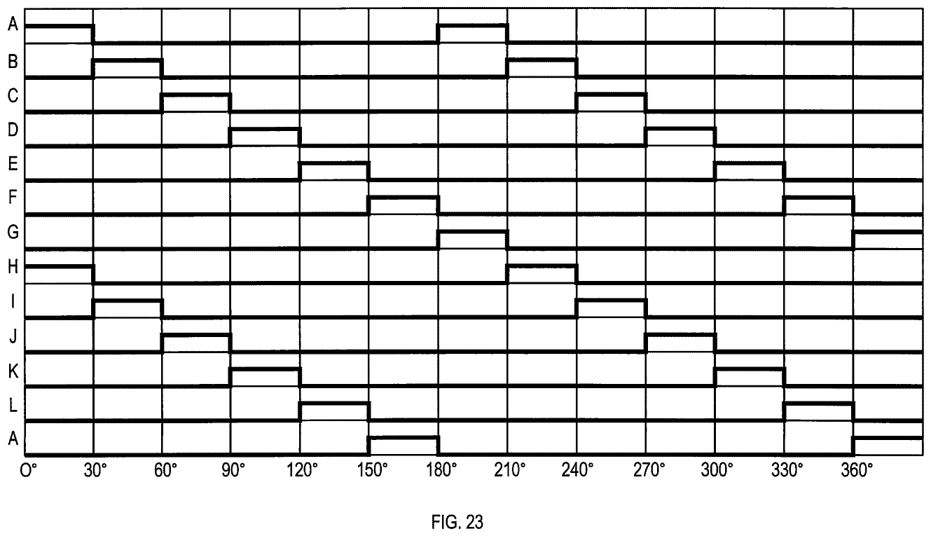

As shown in FIG. 23, the controller 8 in the second embodiment energizes two stator coils 2B that are positioned 180 degrees apart from each other along the ring portion 2C sequentially along the ring portion 2C. This allows each of the first ring rotor 31 and the second ring rotor 32 to perform an operation identical to the operation performed in the first embodiment to thereby rotate.

The rotation of the second ring rotor 32 is transmitted to the first rotation plate 51A via the second output portion 52 and the transmitters 53. The rotation of the first ring rotor 31 is transmitted to the first rotation plate 51A. Thus, rotational forces generated by the first ring rotor 31 and the second ring rotor 32 are output to the output shaft 5B via the first rotation plate 51A.

In the second embodiment, components identical to the components in the first embodiment are given the same reference numerals as those in the first embodiment, and overlapping explanations are omitted.

### <2. Features of Electric Motor in the Second Embodiment>

In the electric motor 1 in the second embodiment, the first ring rotor 31 and the second ring rotor 32 are disposed circumferentially 180 degrees apart from each other relative to the first center O1 and rotate separately.

Therefore, a decentering force generated in association with the rotation of the first ring rotor 31 is canceled out by a decentering force generated in association with the second ring rotor 32. This makes it possible to reduce vibration occurred in the electric motor 1.

### OTHER EMBODIMENTS

In the above-described embodiment, the stator coils 2B are energized one by one. However, the present disclosure is not limited to this. For example, two or more stator coils 2B may be arranged as a set, and the energized stator coils may be changed from one of the sets to another set.

In the aforementioned embodiment, the position of the ring rotor 3 or the eccentric shaft 4 are detected using a magnetic sensor. However, the present disclosure is not limited to this. For example, an optical sensor may be used to detect the position of the ring rotor 3 or the eccentric shaft 4.

The aforementioned embodiment is an example in which the electric motor according to the present disclosure is employed as an electric motor to supply a drive force to a movable part of a vehicle seat. However, the present disclosure is not limited to this and can be applied, for example, for other purposes.

In the aforementioned embodiment, the ring rotor 3 and the eccentric shaft 4 are configured to be rotated by the attraction force generated between the stator coils 2B and the permanent magnets 3A, 3B. However, the present disclosure is not limited to this. For example, the ring rotor 3 and the eccentric shaft 4 may be rotated by a combination of the attraction force and a repulsive force.

In the above-described second embodiment, the plurality of transmitters 53 are provided, and the core 2A is provided with the through holes 2E. However, the present disclosure is not limited to this. For example, at least one transmitter 53 is sufficient, and the through holes 2E may be omitted.

The present disclosure should not be limited to the aforementioned embodiments, but may be implemented in any embodiment that falls within the spirit of the disclosure described in the aforementioned embodiments. Accordingly, the present disclosure may include a configuration obtained by combining at least two of the aforementioned embodiments or a configuration obtained by omitting some of the elements described in the drawings or the elements described with reference numerals in the aforementioned embodiment.

What is claimed is:

1. An electric motor having a stator in which stator coils circumferentially arranged, provided that a center of the circumference is a first center and that a position shifted from the first center is a second center, the electric motor comprising:
a ring rotor that is arranged inside the stator and has an annular shape around the second center, the ring rotor including permanent magnets smaller in number than the stator coils, the permanent magnets being arranged such that north poles and south poles thereof are alternately disposed along an outer circumferential surface of the stator;
an eccentric shaft that is supported to be rotatable about the first center and supports the ring rotor such that the ring rotor is rotatable about the second center;
an output portion that outputs a rotation of the ring rotor about the second center;
a detector that detects a position of the ring rotor or the eccentric shaft; and
a controller that controls a timing for energizing each of the stator coils based on a detection signal from the detector.

2. The electric motor according to claim 1,
wherein, provided that the ring rotor is a first ring rotor, that the output portion is a first output portion, and that a position shifted from the second center by 180 degrees relative to the first center is a third center, the electric motor comprises:
a second ring rotor that is situated inside the stator in a state supported by the eccentric shaft to be rotatable about the third center and has an annular shape around the third center, the second ring rotor including permanent magnets smaller in number than the stator coils, the permanent magnets being arranged such that north poles and south poles thereof are alternately disposed along the outer circumferential surface of the stator; and
a second output portion that outputs a rotation of the second ring rotor about the third center.

3. The electric motor according to claim 2,
wherein the first output portion includes a first rotation plate that is supported rotatably about the first center and a first turning plate that is integrated into the first ring rotor,
wherein one of the first rotation plate and the first turning plate is provided with a first protrusion protruding toward another plate, the other plate being provided with a first hole that allows the first protrusion to fit therein,
wherein the second output portion includes a second rotation plate that is supported rotatably about the first center and a second turning plate that is integrated into the second ring rotor,
wherein one of the second rotation plate and the second turning plate is provided with a second protrusion protruding toward another plate, the other plate being provided with a second hole that allows the second protrusion to fit therein, and
wherein the electric motor further comprises a transmitter that transmits a rotation of the second rotation plate to the first rotation plate.

4. The electric motor according to claim 3,
wherein the first rotation plate and the second rotation plate each has a disc-like shape and includes, at an outer periphery thereof, a toothed portion of a gear,
wherein the transmitter includes a first gear portion that meshes with the toothed portion of the first rotation plate and a second gear portion that meshes with the toothed portion of the second rotation plate.

5. The electric motor according to claim 4,
wherein the stator includes a core that is provided with a through hole through which the transmitter passes.
